(19) United States
(12) Patent Application Publication
(10) Pub. No.: US 2005/0201870 A1
(43) Pub. Date: Sep. 15, 2005

(54) Dosing device

(76) Inventors: Joachim Koerner, Uhldingen (DE); Holger Schuerle, Radolfzell (DE); Michael Helmlinger, Radolfzell (DE)

Correspondence Address: FLYNN THIEL BOUTELL & TANIS, P.C., 2026 RAMBLING ROAD, KALAMAZOO, MI, 49008-1631, US

(21) Appl. No.: 11/073,939

(22) Filed: Mar. 7, 2005

(30) Foreign Application Priority Data
Mar. 5, 2004 (DE) 102004011726.8

(51) Int. Cl. B67D 5/06

(52) U.S. Cl. 417/322

(57) ABSTRACT

A dosing device for dispensing a medium into an environment is disclosed, with a dosing space which is formed by contiguous wall portions and is substantially closed off from an environment; with at least one inlet which passes through at least one wall portion for a communicating connection between the dosing space and a medium reservoir, with a dosing aperture arrangement which passes through at least one wall portion for a communicating connection between the dosing space and the environment, and with at least one vibration means which is fitted on at least one wall portion and which is provided to cause oscillation of at least one wall portion of the dosing space. The dosing aperture arrangement is designed as a separate component and is integrated in a wall portion.

The following disclosure is based on German Patent Application No. 102004011726.8, filed Mar. 5, 2004, which is incorporated into this application by reference.

### FIELD OF THE INVENTION

The invention relates to a dosing device for dispensing a medium into an environment, with a dosing space which is formed by contiguous wall portions and is substantially closed off from an environment, with at least one inlet which passes through at least one wall portion for a communicating connection between the dosing space and a medium reservoir, with a dosing aperture arrangement which passes through at least one wall portion for a communicating connection between the dosing space and the environment, and with at least one vibration means which is fitted on at least one wall portion and which is provided to cause oscillation of at least one wall portion of the dosing space.

### BACKGROUND OF THE INVENTION

A dosing device of this kind is known from European patent application EP 1 129 741. There, a dosing device is described which is made up of an upper substrate and a lower substrate, with wall portions of the substrates delimiting a dosing space which is substantially closed off from an environment. In the wall portions of the upper substrate there are dosing apertures through which the medium to be discharged can be dispensed into the environment of the dosing device. Fitted on an outside of the lower substrate directed away from the dosing space, there is a vibration means which is designed to cause oscillation of the lower substrate and, consequently, of the medium provided in the dosing space. On the dosing device, a lateral inlet is arranged between a wall portion of the upper substrate and a wall portion of the lower substrate, said inlet allowing medium to flow from a medium reservoir into the dosing space.

### SUMMARY OF THE INVENTION

The object of the invention is to make available a device of the type mentioned at the outset which permits easier production and improved dispensing of medium.

This object is achieved by the fact that the dosing aperture arrangement is designed as a separate component and is integrated in a wall portion. In this way, it is possible to use a specific production process that is especially suitable for the dosing aperture arrangement, without taking into account the requirements of the other wall portions of the dosing space, and particularly advantageous properties of the dosing aperture arrangement can thus be obtained. In addition, the other wall portions of the dosing device can be produced in simpler, less expensive and independent production processes using the same or different materials. In particular, production by primary forming or reforming methods is conceivable.

In one embodiment of the invention, the wall portions are provided in separate housing components. In this way, it is possible to specifically adapt the respective production methods used for the housing parts to the requirements of the corresponding wall portions. While a first housing component can be provided in particular for receiving the dosing aperture arrangement and can thus have suitable means for supporting, securing and sealing off the dosing aperture arrangement, a second housing part can be provided specifically for the application of the vibration means and can be designed in particular for conducting the oscillations caused by the vibration means into the dosing space with minimal loss.

The object of the invention is also achieved by the fact that, on the wall portion provided for the application of the vibration means, an elasticity zone is provided for isolating the oscillation from other wall portions. By means of the elasticity zone, it is possible to avoid or at least substantially reduce unwanted oscillation of wall portions remote from the wall portion caused to oscillate by the vibration means. In this way it is also possible in particular to avoid unwanted transmission of the oscillations to components of a medium-discharging device into which the dosing device is generally incorporated, as a result of which the service life of such a discharging device can be improved. In addition, the elasticity zone for isolating the oscillation can permit a particularly advantageous introduction and transmission of the generated vibrations into the dosing space and in particular to the medium to be discharged, as a result of which an advantageous degree of efficiency of the vibration means is achievable. This is of particular interest especially in mobile discharging devices which, with a limited energy supply, are intended to achieve a maximum number of discharging procedures.

In a further embodiment of the invention, the elasticity zone is configured as an at least partially encircling groove and/or bead in the wall portion. This permits particularly advantageous production of the elasticity zone, in particular by primary forming or reforming methods. With an at least partially encircling groove and/or bead of this kind, it is also possible to exert a considerable influence on the oscillation behavior of the medium excited by the vibration means in the dosing space, as a result of which the discharging properties of the dosing device can be influenced in a deliberate manner by the configuration of the elasticity zone. The at least partially encircling groove differs in terms of its mode of action from an at least partially encircling bead since, in the case of a groove, a change in wall thickness of at least one wall portion is provided by which an increase in the elasticity in this wall portion can be achieved. By contrast, in the case of a bead, no change in wall thickness is provided. The change in the oscillation properties is changed primarily by the creation of an in particular undulating geometry of the wall portion which, upon deformation, builds up smaller internal stresses and thus brings about a change in oscillation behavior. An elasticity area can also be made up of encircling grooves and beads arranged in parallel and/or alternating, so that a particularly preferred oscillation behavior is achieved. In a further embodiment, a bead-like configuration of a groove is also conceivable.

In a further embodiment of the invention, at least one housing part is made of an elastic material. Elastic materials in question are in particular plastics, metals, composites of plastics and metals, in particular reinforced with glass fibers and/or carbon fibers. By using an elastic material, the oscillation properties in particular of the dosing device can be preset within a wide spectrum, as a result of which it is possible to substantially influence the energy consumption and the number and size of the liquid particles discharged.

In a further aspect of the invention, at least one channel portion communicating with the dosing space and with the environment and/or the medium reservoir is provided in at least one wall portion. By means of such a channel portion, which in particular can be filled with medium immediately in advance of performing a medium-discharging procedure, in particular with capillary forces permitting filling of the channel portion, advantageous supply of the dosing space with medium during the discharging procedure can be achieved. In a preferred embodiment of the invention, the discharging procedure from the dosing space takes place free from pressure in order to guarantee a predeterminable distribution of the number of droplets and size of droplets. That is to say, a delivery means provided for delivering the medium from a medium reservoir into the dosing space is inactive during the discharging procedure, and an inlet line from the medium reservoir into the dosing space is closed in particular by a valve means. Nevertheless, in order to be able to discharge a sufficient quantity of medium from the dosing space into the environment, and at the same time be able to limit the size of the dosing space to a volume smaller than the quantity of medium to be discharged, so as to achieve an advantageous discharge behavior of the medium, the at least one channel portion is provided which is connected to and communicates with the dosing space, but at any rate is provided directly in the area of an oscillation propagation through the vibration means. In this way, a compact dosing space with a small-dimension vibration means can be realized, which can be adapted exactly to the requirements of the discharging procedure and which nevertheless permits discharge of the desired quantity of medium. The inflow of medium from the channel portion into the dosing space also ensures that the medium to be discharged is not excessively heated by the effect of oscillation or, in the case of sensitive components of the medium, is not degenerated by the effect of oscillation.

In a further embodiment of the invention, the channel portion is arranged at least partially encircling the dosing space. This permits a particularly compact integration of one or more channel portions into one or more wall portions, and depending on the nature and duration of the discharging procedure and the medium to be discharged, inlet openings of the channel portion or channel portions in the dosing space can be distributed regularly or irregularly on the dosing space, so that the medium emerging from the channel portion or channel portions into the dosing space enters at exactly predeterminable, optimized locations. In a preferred embodiment, an annular channel portion is provided for supplying the whole dosing space uniformly with medium.

In a particularly preferred embodiment, the channel portion or channel portions are arranged circularly and/or point-symmetrically encircling the dosing space, by which means it is possible to achieve a particularly compact arrangement of the channel portions and a homogeneous and low-friction inflow of medium into the dosing space.

In a further embodiment of the invention, the channel portion is designed at least partially in a meandering configuration. In this way, a particularly compact integration of the channel portion into the wall portion is permitted. By means of the at least partially curved course of the channel portion, a particularly favorable ratio can be achieved between a channel portion length, a channel portion volume, and a surface area required for this length or this volume in the wall portion. The meandering configuration of the channel portion can be realized particularly advantageously by providing positively and negatively curved channel portions in close succession.

In a further embodiment of the invention, the channel portion is designed as a groove open on one side. In this way, the channel portion can be formed inexpensively and in a particularly simple technical manner during primary forming or reforming of the corresponding wall portion. By means of the groove configuration open on one side, channel portions in particular which are to be fillable by capillary forces can be realized in a simple way since the extremely small channel cross sections required for this can be introduced from an outside surface of the wall portion.

In a further embodiment of the invention, the channel portion is closed off at least substantially from the environment by a housing part lying flat on top of it. In this way it is possible to obtain in a particularly simple manner a channel portion which is closed off at least substantially from the environment. In a preferred embodiment, a ventilation opening, delimited from the environment in particular by a filter unit, is provided at an end of the channel portion remote from the dosing space. Air or a protective gas can in particular flow through the ventilation opening and into the channel portion in order to make it easier for the medium stored in the channel portion to flow into the dosing space during the discharging procedure.

In a further embodiment of the invention, the wall portion lying on the channel portion is configured at least partially as a filter membrane. In this way it is possible to ensure a flow of medium into the dosing space during the discharging procedure from the channel portion, without contamination being able to enter the channel portion from the environment of the dosing device. In a particularly preferred embodiment, the filter membrane is designed as a hydrophobic and/or liquid-tight membrane with microbe-excluding action, so that, when the channel portion is being filled with medium, escape of the medium through the filter membrane is ruled out. At the same time, it is ensured that microbes or other contaminating substances cannot pass through the filter membrane and into the channel portion.

In a further embodiment of the invention, housing parts are connected to one another cohesively at least in sections. By means of a cohesive connection of the housing parts, in particular in the area of the wall portions delimiting the dosing space and/or the channel portions, a liquid-tight connection between the housing parts can be preferably obtained. A cohesive connection between the housing parts can be realized in particular by adhesive bonding, ultrasound welding or laser welding.

In a further embodiment of the invention, the dosing aperture arrangement and/or the vibration means is injected in a wall portion configured as an injection-molded plastic part. This permits a particularly intimate connection between the dosing aperture arrangement and/or the vibration means and the corresponding wall portion. In addition, the material from which the wall portion is constructed is only slightly disturbed in a connection area between the dosing aperture arrangement and/or the vibration means and the wall portion, since it is possible to dispense with subsequent energy input and/or solvents contained in otherwise necessary adhesives.

In a further embodiment of the invention, electrical conductor tracks for contacting of electrical components are provided in and/or on wall portions made of electrically insulating material. These conductor tracks, which are produced in particular using a multi-component injection molding method, permit simple integration of electrical consumers, sensors and/or switches into the wall portions. It is thus possible to dispense with expensive contacting measures after production of the corresponding wall portions. In this way, it is possible to obtain particularly easy and reliable contacting of the electrical components. The conductor tracks can also be produced by subsequent application of PVD metal coatings, screen printing or pad printing of metal layers or in a similar manner.

In a further embodiment of the invention, contiguous housing parts have forced positioning means, which are provided for a form-fit, positionally correct mounting of the housing parts relative to one another. This permits particularly simple and reliable, positionally correct mounting of the housing parts relative to one another. For this purpose, the forced positioning means on the housing parts are configured in particular as form-fitting grooves, passages, pins and/or catches which can guarantee unambiguous positioning of contiguous housing parts and self-retaining, form-fit connection of the housing parts.

### BRIEF DESCRIPTION OF THE DRAWINGS

Further advantages and features of the invention will become evident from the claims and from the following description of preferred illustrative embodiments made with reference to the drawings.

FIG. 1 shows an exploded perspective view of a dosing device with an upper part, a separate dosing aperture arrangement, a lower part, and a vibration means,

FIG. 2 shows an exploded perspective view of the dosing device according to FIG. 1 with a view of concealed edges,

FIG. 3 shows a plane cross-sectional view of the dosing device according to FIGS. 1 and 2, and

FIG. 4 shows an exploded perspective view of a dosing device with outwardly directed channel portions which are sealed by a filter membrane, and with a dosing space configured at least partially as a metal membrane.

### DETAILED DESCRIPTION OF THE INVENTION

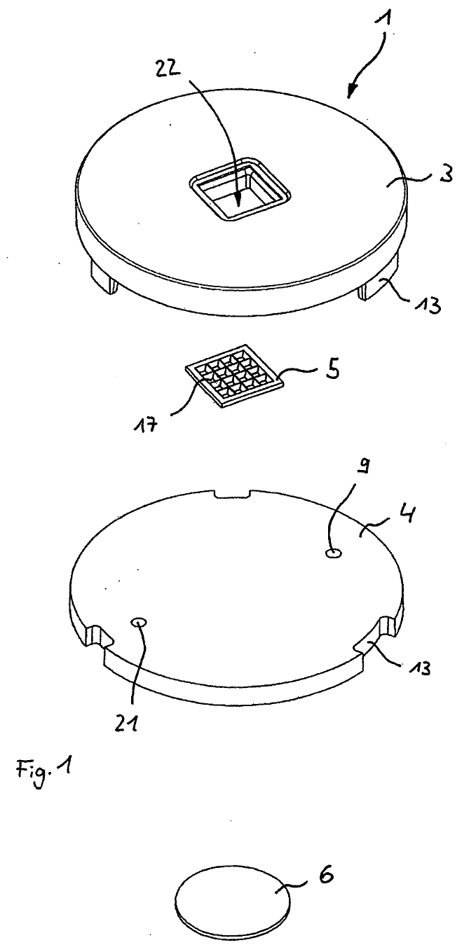

In the embodiment of the invention shown in FIGS. 1 to 3, a dosing device 1 is made up principally of an upper part 3, a lower part 4, a dosing aperture arrangement 5, and a vibration means 6. The dosing aperture arrangement 5 made of silicon material is introduced into the upper part 3 from the direction of an underside of said upper part 3 and is secured with an adhesive connection 14. For reliable provision of the adhesive connection 14, the upper part 3 is provided with a groove 16 for adhesive arranged around a recessed receiving area 15. This groove 16 for adhesive permits escape of excess adhesive during the adhesion procedure and thus ensures that a front face of the dosing aperture arrangement 5 provided with dosing apertures 17 is not contaminated by adhesive.

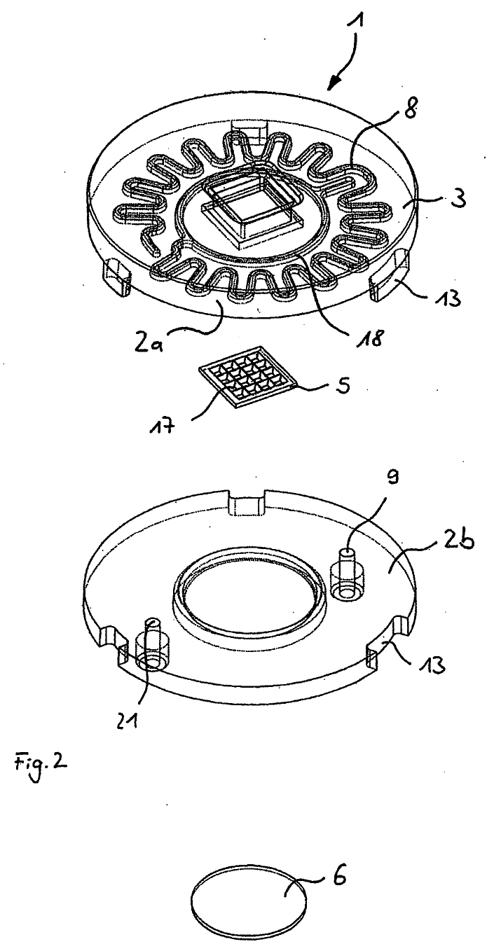

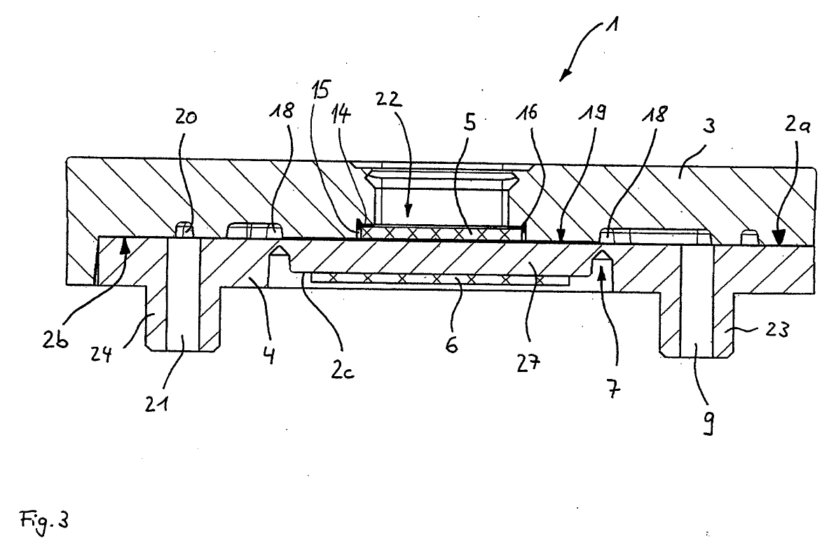

As is shown in FIG. 2, a channel portion 8 arranged circularly about an outlet shaft 22 and of meandering configuration is provided on the underside of the upper part 3. The meandering channel portion 8 has an annular channel 18 which has a communicating connection with the dosing space 19 shown in more detail in FIG. 3. The annular channel 18 is also connected to communicate with an inlet 9 which in turn establishes a connection (not shown) with a medium reservoir. At an end of the channel portion 8 remote from the annular channel 18, a ventilation opening 20 is provided which is connected so as to communicate with a ventilation channel 21 which in turn opens either into an environment or into the medium reservoir in order to permit emptying of the channel portion 8 during the discharging procedure. Provided on the upper part 3, above the dosing aperture arrangement 5, is the outlet shaft 22 through which the medium to be discharged can be dispensed into an environment. On the lower part 4, an inlet nozzle 23 is provided for the inlet 9, and a ventilation nozzle 24 is provided for the ventilation channel 21. Tubular connection channels (not shown), particularly for connection of the medium reservoir, can easily be applied to the inlet nozzle 23 and to the ventilation nozzle 24. Provided in the lower part 4 there is an elasticity zone 7 which is configured as a circular groove and which isolates the centrally applied vibration means 6 from the rest of the lower part 4. The lower part 4 and the upper part 3 form, with their respective opposite wall portions 2a, 2b, the dosing space 19, which is additionally delimited by the dosing aperture arrangement 5. For this purpose, the wall portions 2a, 2b lie flat on one another and are cohesively connected to one another at least in part, in particular by laser welding.

The vibration means 6 is likewise fitted cohesively on an outwardly directed wall portion 2c and is connected to electrical contacting means (not shown) for supplying power to generate oscillations. In the present embodiment, the dosing space 19 has a height of approximately 50 μm. It will thus be apparent that the meandering channel portion 8 including the annular channel 18 has a substantially greater volume than the dosing space 19. A substantially pressure-free discharging procedure for the medium can thus dispense a multiple of the quantity of liquid that can be directly received in the dosing space 19, without further delivery of medium from the medium reservoir (not shown) via the inlet 9 being needed.

In terms of its volume, the dosing space 19 is negligible in relation to a filling volume of the channel portion 8 and of the annular space 18 which together form a pre-dosing chamber. The overall filling volume of the annular space 18 and of the channel portion 8 is preferably dimensioned such that it is at least substantially equal to, or an integral multiple of, the dosing quantity to be discharged via one piezo actuation. This means that, with complete filling of the pre-dosing chamber and with a corresponding dosing actuation, it is ensured that the pre-dosing chamber is either completely emptied or still has enough liquid to ensure that one or more complete discharging procedures can be performed. Since, after an integral number of discharging procedures, the pre-dosing chamber is necessarily completely emptied, an exactly adapted dosing quantity can then be achieved again by complete filling.

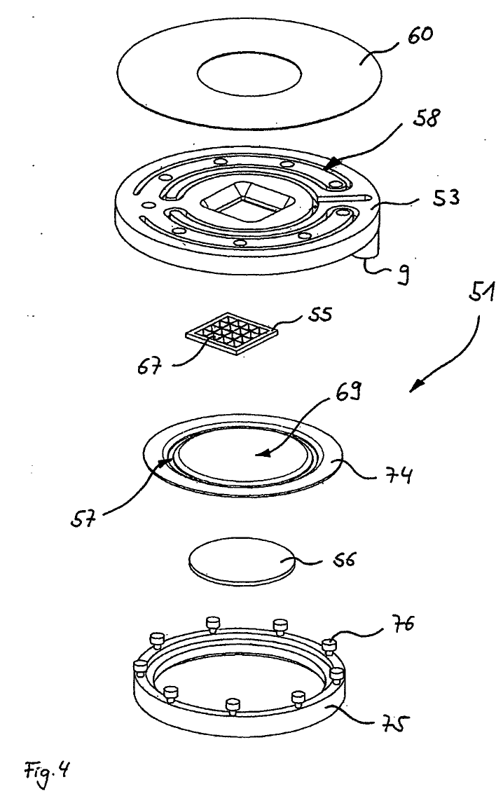

In the embodiment of the invention shown in FIG. 4, the channel portion 58 is formed as an open groove in a front face of the upper part 53 directed outward away from the dosing space and is sealed by means of a filter membrane 60 which can be mounted cohesively on the front face of the upper part 53. The filter membrane 60 is configured at least partially as a hydrophobic, gas-permeable and microbe-excluding membrane and thus allows the surrounding atmosphere, in particular air, to flow into the channel portion 58 during the discharging procedure. During filling of the channel portions, which can be done in particular by capillary forces, the filter membrane 60 permits outward flow of air displaced by the inflowing medium. The dosing aperture arrangement 55 corresponds to the one in FIGS. 1 to 3, i.e. dosing apertures 67 are also provided here. The cohesive connection of the dosing aperture arrangement 55 to the upper part 53 is also executed in the same way as in the embodiment in FIGS. 1 to 3.

The dosing space 69 is delimited at the bottom by a metal membrane 74, and a circular and concentrically arranged elasticity zone 57 designed as a bead is provided in the metal membrane 74. The vibration means 56 is mounted cohesively on an underside of the metal membrane 74 and is electrically contacted in the same way as the vibration means 6 according to FIGS. 1 to 3. The metal membrane 74 is held with a form fit in the upper part 53 by means of a centering ring 75 provided with press studs 76. The press studs 76 ensure that an upper face of the metal membrane 74 lies flat in relation to an underside of the upper part 53.

For discharging a medium by means of a dosing device according to FIGS. 1 to 3, the medium stored in a medium reservoir (not shown) is first conveyed, directly before the start of the medium discharging procedure, via delivery means (likewise not shown) which are connected mechanically to the inlet nozzle 23, via the inlet 9 and into the annular channel 18 and thus both into the channel portion 8 and also into the dosing space 19. Any excess medium can be led off via the ventilation opening 20 into the ventilation channel 21 which is connected via the ventilation nozzle 24 in particular to the medium reservoir. Thus, a correct filling of the dosing space and of the channel portion with a pre-defined quantity of medium is guaranteed exclusively by the geometric configuration of the dosing space and of the channel portion. The delivery means for delivering the medium from the medium reservoir does not therefore have to satisfy especially stringent demands in respect of its precision.

The quantity supplied by the delivery means is in any case set so as to be greater than the maximum filling volume of the channel portion and of the annular space and, consequently, of the pre-dosing chamber. Excess liquid is automatically conveyed back to the medium reservoir via the ventilation nozzle. A complete and thus defined filling is thus at all times guaranteed, without the delivery means needing to meet special requirements in respect of exact dosing. Delivery is also to be understood as transport of medium by capillary action. In this case, the delivery means is defined by a shut-off member which shuts off or releases the filling by capillary action.

After complete filling of the dosing space 19 and of the channel portion 18, a valve means (not shown) between the medium reservoir and the inlet 9 is closed. The medium introduced into the dosing space 19 and into the channel portion 18 is thus to be regarded as substantially free of pressure. By supplying electrical power to the vibration means 6 via an actuation device (not shown) and via supply lines (also not shown), the central oscillation portion 27 of the lower part 4 delimited by the elasticity zone 7 is then caused to vibrate, which leads to compression of the medium enclosed in the dosing space 19. In this way, the medium can pass out through the dosing apertures 17 (not shown in detail) of the dosing aperture arrangement 5 and into the outlet shaft 22 of the upper part 3 and can be dispensed from there into an environment. Upon a volume increase following on from the volume reduction of the dosing space 19, medium stored in the annular channel 18 and in the channel portion 8 can flow into the dosing space and is thus made available for a subsequent discharging procedure following immediately and defined by the frequency of the vibration means 6. This ensures that the discharging procedure from the dosing space 19 into the environment can take place with a particularly advantageous degree of efficiency since, for each discharging procedure, only a small quantity of liquid has to be accelerated by the vibration means 6. Moreover, by means of more medium flowing from the annular channel 18 or channel portion 8, a long-lasting discharging procedure can be guaranteed without the need for re-dosing from the medium reservoir.

1. Dosing device for dispensing a medium into an environment,
with a dosing space which is formed by contiguous wall portions and is substantially closed off from an environment;
with at least one inlet which passes through at least one wall portion for a communicating connection between the dosing space and a medium reservoir;
with a dosing aperture arrangement which passes through at least one wall portion for a communicating connection between the dosing space and the environment;
and with at least one vibration means which is fitted on at least one wall portion and which is provided to cause oscillation of at least one wall portion of the dosing space, characterized in that the dosing aperture arrangement is designed as a separate component and is integrated in a wall portion.

2. Dosing device according to claim 1, wherein the wall portions are provided in separate housing parts.

3. Dosing device according to claim 1, further comprising on the wall portion provided for the application of the vibration means, an elasticity zone for isolating the oscillation from other wall portions.

4. Dosing device according to claim 3, wherein the elasticity zone is configured as an at least partially encircling groove and/or bead in the wall portion.

5. Dosing device according to claim 2, wherein at least one housing part is made of an elastic material, in particular of plastic or metal.

6. Dosing device according to claim 1, further comprising at least one wall portion having at least one channel portion communicating with the dosing space and with the environment and/or the medium reservoir.

7. Dosing device according to claim 6, wherein the channel portion is arranged at least partially encircling the dosing space, in particular in a circular and/or point-symmetrical configuration.

8. Dosing device according to claim 6, wherein the channel portion is designed at least partially in a meandering configuration.

9. Dosing device according to claim 6, wherein the channel portion is designed as a groove open on one side.

10. Dosing device according to claim 6, wherein the channel portion is closed off at least substantially from the environment by a wall portion lying flat thereon.

11. Dosing device according to claim 10, wherein the wall portion lying on the channel portion is configured as a filter membrane.

12. Dosing device according to claim 1, wherein the dosing aperture arrangement and/or the vibration means is injected in a wall portion configured as an injection-molded plastic part.

13. Dosing device according to claim 1, wherein in and/or on wall portions made of electrically insulating materials, electrical conductor tracks, produced in particular by multi-component injection molding, are provided for contacting of electrical components.

14. Dosing device according to claim 2, wherein contiguous housing parts have forced positioning means, in particular grooves and catches, which are provided for a form-fit, positionally correct mounting of the housing parts relative to one another.

15. Dosing device according to claim 6, wherein a delivery means for filling at least the channel portion is controlled in such a way that an inflow of medium into the channel portion has in each case a greater volume than a maximum filling volume of the channel portion, and the channel portion, remote from an inlet opening, has a ventilation channel connected to a medium reservoir at least during the filling procedure.
